(19) United States
(12) Patent Application Publication
(10) Pub. No.: US 2018/0186178 A1
(43) Pub. Date: Jul. 5, 2018

(54) ISOLATOR DESIGN FOR VEHICLE WHEEL

(71) Applicant: GM Global Technology Operations LLC, Detroit, MI (US)

(72) Inventors: Ming LIU, Shanghai (CN); Lei GAO, Shanghai (CN)

(21) Appl. No.: 15/741,529

(22) PCT Filed: Jul. 10, 2015
(86) PCT No.: PCT/US2015/039924

§ 371 Date: Jan. 3, 2018

(51) Int. Cl. B60B 3/14

(52) U.S. Cl. CPC B60B 3/145; B60B 2360/102; B60B 2360/106; B60B 2900/141

(57) ABSTRACT

A number of variations may include a vehicle which may have a vehicle body and a vehicle hub operably coupled to the vehicle body. A vehicle wheel may be operably coupled to the vehicle hub. The vehicle wheel may be isolated from the vehicle hub by at least one isolation feature selected from the group consisting of: an extended flange portion of the vehicle wheel may be disposed between a pilot hole and the vehicle hub, a multiple piece cover portion may fully cover the pilot hole, a drain slot may be disposed on the vehicle wheel and the drain slot may have a slope of at least five degrees, or an enhanced bushing may create a non-flat profile between the vehicle wheel and a fixation device.

### TECHNICAL FIELD

The field to which the disclosure generally relates to includes vehicles.

### BACKGROUND

Vehicles may include various components.

### SUMMARY OF ILLUSTRATIVE VARIATIONS

A number of variations may include a vehicle which may have a vehicle body and a vehicle hub operably coupled to the vehicle body. A vehicle wheel may be operably coupled to the vehicle hub. The vehicle wheel may be isolated from the vehicle hub by at least one isolation feature selected from the group consisting of: an extended flange portion of the vehicle wheel may be disposed between a pilot hole and the vehicle hub, a multiple piece cover portion may fully cover the pilot hole, a drain slot may be disposed on the vehicle wheel and the drain slot may have a slope of at least five degrees, or an enhanced bushing may create a non-flat profile between the vehicle wheel and a fixation device.

A number of other variations may include a vehicle which may have a vehicle wheel operably coupled to a vehicle hub. The vehicle wheel may be isolated from the vehicle hub by one or more of the following: an extended flange portion of the vehicle wheel may be disposed between a pilot hole and the vehicle hub, a multiple piece cover may be disposed fully covering the pilot hole, drain slots may be disposed on the vehicle wheel and the drain slots may have a slop of at least five degrees, or an enhanced bushing may create a non-flat profile between the vehicle wheel and a fixation device.

Yet a number of other variations may include an isolation feature which may be constructed and arranged to isolate a vehicle wheel from a vehicle hub and may include at least one of the following: an extended flange which may be disposed between a pilot hole and the vehicle hub, a multiple piece cover portion which may fully cover the pilot hole, drain slots which may be disposed on the vehicle wheel and the drain slots may have a slope of at least five degrees, or an enhanced bushing which may create a non-flat profile between the vehicle wheel and a fixation device.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 shows a vehicle wheel according to a number of variations of the present invention;

FIG. 2 shows an isolation feature according to a number of variations of the present invention;

FIG. 3 shows the isolation feature according to a number of variations of the present invention;

FIG. 4 shows the isolation feature according to a number of variations of the present invention;

FIG. 5 shows the isolation feature according to a number of variations of the present invention;

FIG. 6 shows the isolation feature according to a number of variations of the present invention;

FIG. 7 shows the isolation feature according to a number of variations of the present invention;

FIG. 8A shows the isolation feature according to a number of variations of the present invention;

FIG. 8B shows the isolation feature according to a number of variations of the present invention;

FIG. 8C shows the isolation feature according to a number of variations of the present invention;

FIG. 8D shows the isolation feature according to a number of variations of the present invention; and

FIG. 8E shows the isolation feature according to a number of variations of the present invention.

### DETAILED DESCRIPTION OF ILLUSTRATIVE VARIATIONS

The following description of the variations is merely illustrative in nature and is in no way intended to limit the scope of the invention, its application, or uses.

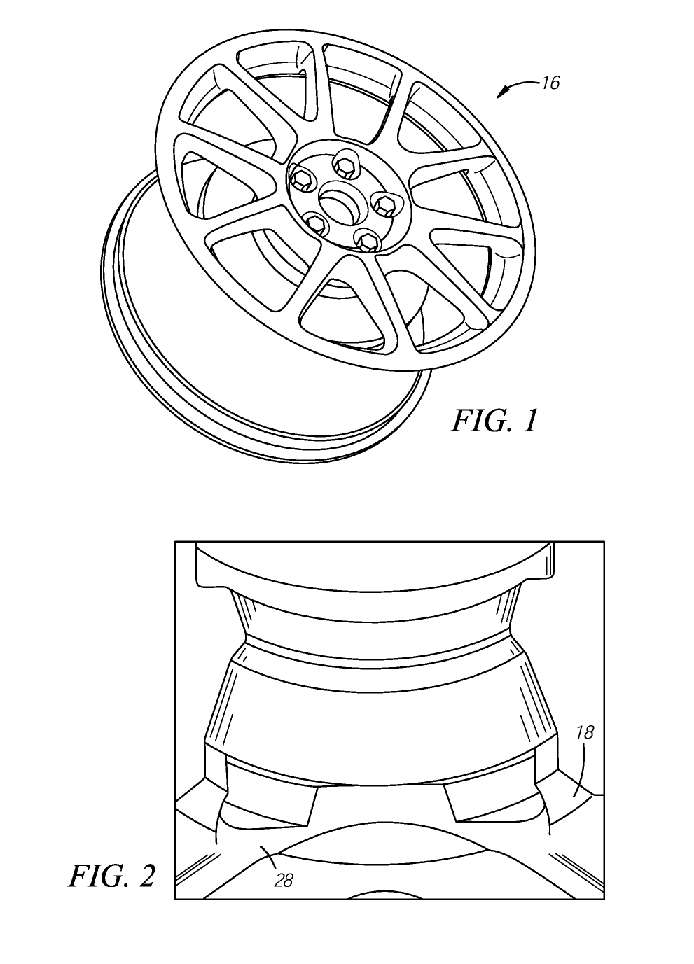

Referring now to the variation illustrated in FIG. 1, a vehicle 10 may be provided and may include a vehicle body 12 and additionally may include a vehicle hub 14 which may be operably coupled to the vehicle body 12. Moreover, a vehicle wheel 16 may be operably coupled to the vehicle hub 14. The vehicle wheel 16 may be isolated from the vehicle hub 14 by at least one isolation feature 18. It is contemplated that the isolation feature 18 may be selected from one or more of the following: an extended flange portion 20 of the vehicle wheel 16 may be disposed between a pilot hole 22 and the vehicle hub 14, a multiple piece cover portion 24 may fully cover the pilot hole 22, a drain slot 28 may be disposed on the vehicle wheel 16, or an enhanced bushing 30 may create a non-flat profile between the vehicle wheel 16 and a fixation device 32.

Referring still to the variation illustrated in FIG. 1, the vehicle wheel 16 may be a standard vehicle wheel as known by one of ordinary skill in the art. As shown in FIG. 1, the wheel 16 may have multiple spokes, or may have another configuration as known by one of ordinary skill in the art. Moreover, it is contemplated that the vehicle wheel 16 may be comprised of magnesium. It is also contemplated that the wheel may be comprised of steel or any other material as known by one of ordinary skill in the art. Additionally, it is contemplated that the vehicle wheel 16 may have a coating which may be constructed and arranged to be a surface protectant of the vehicle wheel 16.

Referring now to the variation illustrated in FIG. 2, the isolation feature 18 may be constructed and arranged to isolate the vehicle wheel 16 from the vehicle hub 14, and additionally or alternatively, may be constructed and arranged to drain corrosive liquid out of the vehicle wheel 16. As illustrated in the variations shown in FIGS. 1 and 2, the vehicle wheel may include at least one pilot hole 22, and may additionally include at least one drain slot 28. It is contemplated that any number of pilot holes 22 and/or drain slots 28 may be disposed on the vehicle wheel 16.

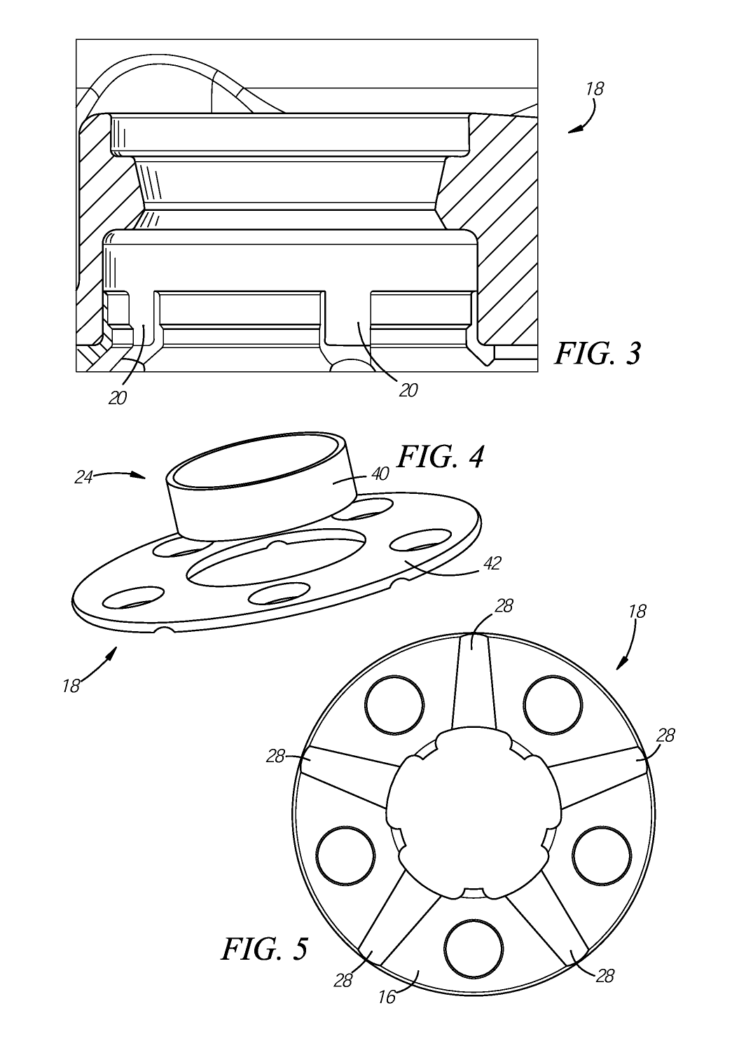

Referring now to the variation illustrated in FIG. 3, one of the isolation features 18 may include an extended flange 20 which may be configured to isolate the pilot hole 22 of the vehicle wheel 16 from the vehicle hub 14. The flange 20 may be disposed on the vehicle wheel 16, and may separate the pilot hole 22 and the vehicle hub 14. It is contemplated that the flange portion 20 may partially or completely isolate the pilot hole 22 portion of the vehicle wheel 16 from the vehicle hub 14. It is contemplated that isolating the pilot hole 26 from the hub 14 may limit or eliminate galvanic corrosion between the wheel 16 and the hub 14 which may occur inside or around the pilot hole 22. The flange 20 may be configured in any shape and may be comprised of magnesium or any other material in order to isolate the pilot hole 22 from the vehicle hub 14.

Referring now to the variation illustrated in FIG. 4, the isolation feature 18 may include a two-piece cover 24 which may be constructed and arranged to fully cover the pilot hole 22. As illustrated in FIG. 4, a first piece 40 of the two-piece cover 24 may be a ring like structure which may be configured to be placed on an inside surface of the vehicle wheel 16. The second piece 42 of the two-piece cover 24 may be a flat portion which may be constructed and arranged to cover an outside surface of the vehicle wheel 16. Additionally, it is contemplated that the two-piece cover 24 may completely or partially cover the pilot hole 22 and may eliminate or significantly reduce galvanic corrosion on the vehicle wheel 16. It is also contemplated that the two-piece cover portion 24 may be of any size or shape in order to fully cover the pilot hole 22 as known by one of ordinary skill in the art.

Referring now to the variation illustrated in FIG. 5, the vehicle wheel 16 may include drain slots 28 which may be constructed and arranged to drain water or other liquid out of the vehicle wheel 16. It is contemplated that there may be five drain slots 28 as illustrated in the variation shown in FIG. 5. It is additionally contemplated that any number of drain slots 28 may be used in the vehicle wheel as desired by one of ordinary skill in the art. It is contemplated that the drain slots 28 may extend from a distal end of the vehicle wheel 16 to a proximal center of the vehicle wheel 16. It is also contemplated that the distal end of the drain slots 28 may have a smaller width than the proximal end of the drain slot 28. It is also contemplated that any other configuration of drain slot 28 as known by one of ordinary skill in the art may be used.

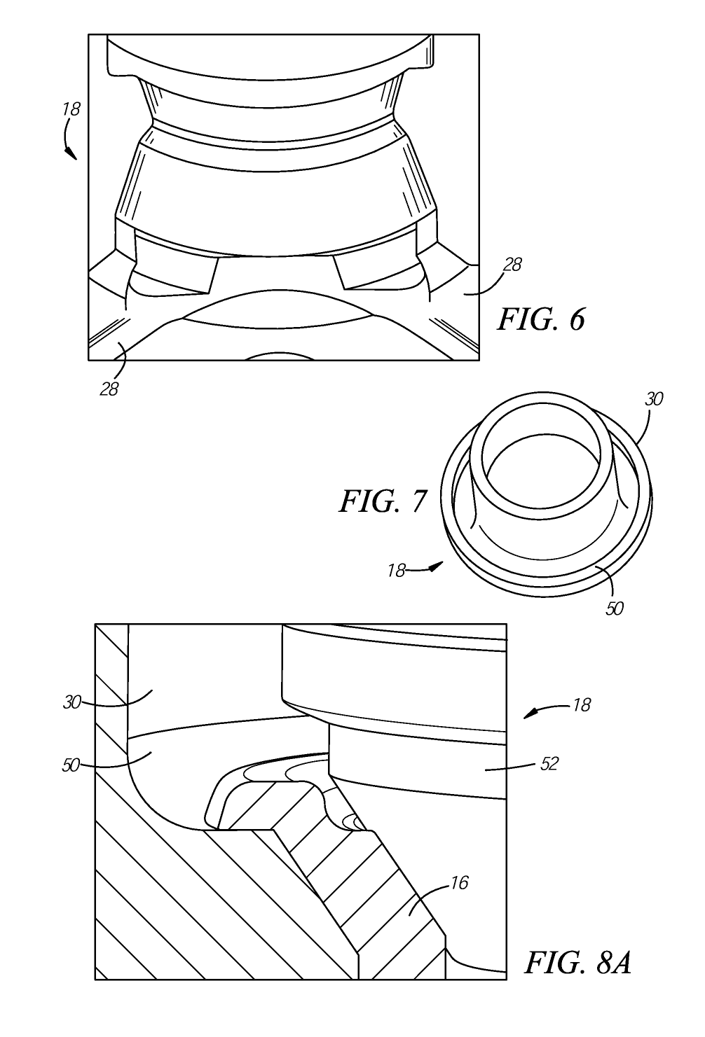

Referring now to the variation illustrated in FIG. 6, it is contemplated that the vehicle wheel 16 may include drain slots 28 which may have a slope interface which may be configured to drain water out of the wheel 16. It is contemplated that the drain slots 28 may have a slope of approximately five degrees to approximately fifteen degrees. Additionally it is contemplated that the slope may be of any degree as desired by one of ordinary skill in the art. It is contemplated that one or more or all of the drain slots 28 may have a slope interface as desired by one of ordinary skill in the art. The drain slots 28 may be shaped and/or configured similar to the variation illustrated in FIG. 5, however, it is also contemplated that the drain slots 28 may have a different shape or configuration as desired by one of ordinary skill in the art. Additionally, as illustrated in the variation shown in FIG. 6, the pilot hole 22 may additionally or alternatively include a slope interface. The slope interface of the pilot hole 22 may be approximately five degrees to approximately fifteen degrees. It is contemplated that pilot hole 22 may be constructed and arranged to drain water out of the vehicle wheel which may prevent galvanic corrosion. Moreover, as additionally illustrated in FIG. 6, the vehicle wheel 16 may itself have a slope interface alternatively or in conjunction with the sloped drain slots or the sloped pilot hole. It is contemplated that the vehicle wheel 16 may include a vehicle slope interface of approximately five degrees to approximately fifteen degrees and may be constructed and arranged to drain water or other liquid out of the vehicle wheel 16.

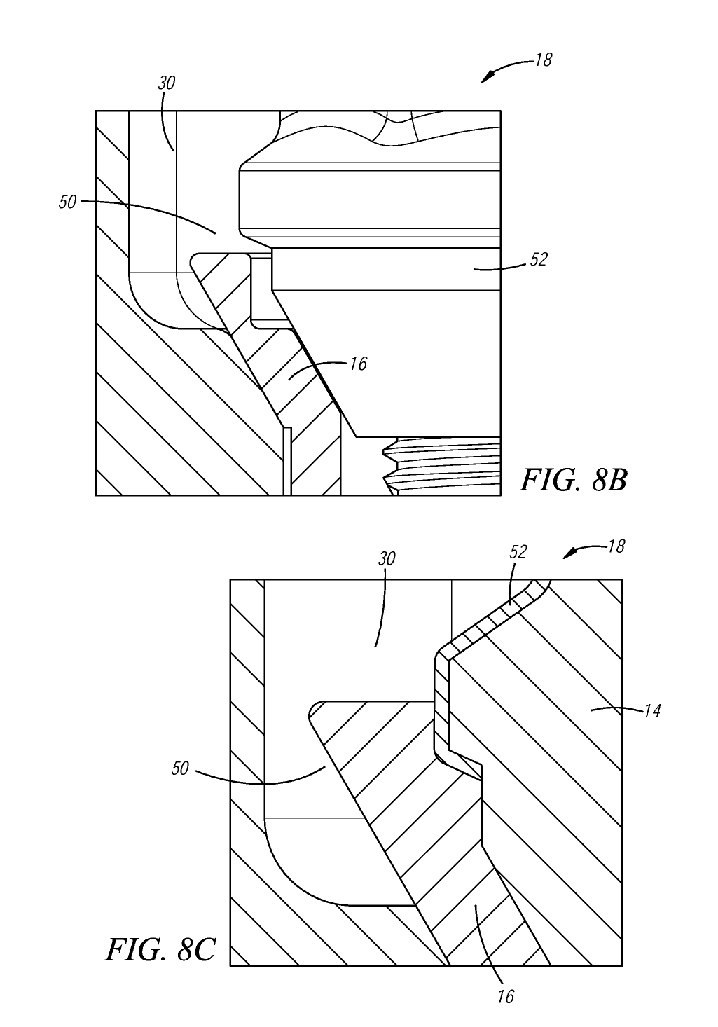

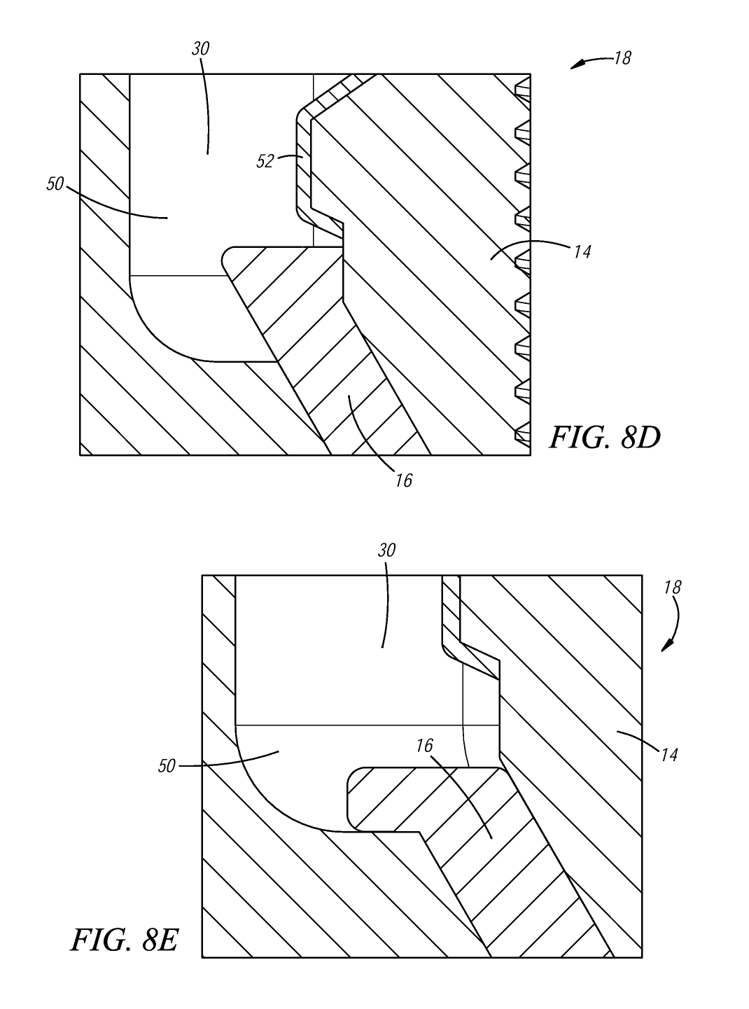

Referring now to the variation illustrated in FIG. 7, it is contemplated that the vehicle wheel 16 may include the enhanced bushing 30. The enhanced bushing 30 may include a flange 50 surrounding one end of the bushing. It is contemplated that the flange 50 may be constructed and arranged to isolate the vehicle wheel 16 from the vehicle hub 14. As illustrated in the variations shown in FIGS. 8A-8E, the enhanced bushing 30 may be constructed and arranged to isolate the vehicle wheel 16 from a nut 52. The enhanced bushing 30 may create a non-flat profile between the vehicle wheel 16 and the nut 52 which may result in a bigger isolation barrier. Moreover, the enhanced bushing 30 may not include a groove in order to possibly eliminate liquid accumulation. Moreover, the flange 50 may be constructed and arranged to increase load resistance of the bushing 30.

Referring now to the variations illustrated in FIGS. 8A-8E, it is contemplated that the flange 50 which may surround the bushing 30 may be of any configuration in order to isolate the nut 52 from the vehicle wheel 16. As illustrated in FIGS. 8A and 8E, the flange 50 may come to a rectangular end and may form a rectangular barrier between the nut 50 and the vehicle wheel 16. Moreover, it is contemplated as illustrated in FIGS. 8B and 8D, that the flange 50 may extend into a point or a semi-point such that the nut 52 is isolated from the vehicle wheel 16. Moreover, it is contemplated as shown in FIG. 8C, that the nut 52 may extend around the vehicle wheel 16 and may isolate the wheel 16 from the nut 52. It is additionally contemplated that the flange 50 of the enhanced bushing 30 may form a water barrier such that water or the liquid is not able to contact the vehicle wheel 16. The enhanced bushing 30 may help foster the vehicle wheel 16 having little or no galvanic corrosion. Further, it is contemplated that any of the variations illustrated in FIG. 8A-8E may be used alternatively or in conjunction with any of the isolation features 18 shown in FIGS. 3-6.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a vehicle which may include a vehicle body, and additionally may include a vehicle hub which may be operably coupled to the vehicle body. The vehicle wheel may be operably coupled to the vehicle hub. The vehicle wheel may be isolated from the vehicle hub by at least one isolation feature. The isolation feature may be selected from the group which may consist of: an extended flange portion of the vehicle wheel disposed between a pilot hole and the vehicle hub, a multiple piece cover portion which may fully cover the pilot hole, drain slots which may be disposed on the vehicle wheel wherein the drain slots may have a slope of at least five degrees, or an enhanced bushing which may create a non-flat profile between the vehicle wheel and a fixation device.

Variation 2 may include the vehicle as set forth in Variation 1 wherein the vehicle wheel may be comprised of magnesium.

Variation 3 may include the vehicle as set forth in any of Variations 1 or 2 wherein the vehicle hub may be comprised of steel.

Variation 4 may include the vehicle as set forth in any of Variations 1-3 wherein the fixation device may be comprised of steel.

Variation 5 may include the vehicle as set forth in any of Variations 1-4 wherein the drain slots have a slope of up to fifteen degrees.

Variation 6 may include the vehicle as set forth in any of Variations 1-5 wherein the drain slots may have a width of up to 20 mm.

Variation 7 may include the vehicle as set forth in any of Variations 1-6 wherein a width of a distal end of the drain slot may be smaller than a width of the proximal end of the drain slot.

Variation 8 may include a vehicle which may include a vehicle wheel which may be operably coupled to the vehicle hub. The vehicle wheel may be isolated from the vehicle hub by one or more of the following: an extended flange portion of the vehicle which may be disposed between a pilot hole and the vehicle hub, a multiple piece cover portion may fully cover the pilot hole, drain slots may be disposed on the vehicle wheel and the drain slots may have a slope of at least five degrees, or an enhanced bushing may create a non-flat profile between the vehicle wheel and a fixation device.

Variation 9 may include the vehicle as set forth in Variation 8 wherein the vehicle wheel may be comprised of magnesium.

Variation 10 may include the vehicle as set forth in any of Variations 8-9 wherein the vehicle hub may be comprised of steel.

Variation 11 may include the vehicle as set forth in any of Variations 8-10 wherein the fixation device may be comprised of steel.

Variation 12 may include the method as set forth in any of Variations 8-11 wherein the drain slots may have slope of up to fifteen degrees.

Variation 13 may include the vehicle as set forth in any of Variations 8-12 wherein the drain slots may have a width of up to 20 mm.

Variation 14 may include the vehicle as set forth in any of Variations 8-13 wherein a width of a distal end of the drain slot may be smaller than a width of the proximal end of the drain slot.

Variation 15 may include an isolation feature which may be constructed and arranged to isolate a vehicle wheel from a vehicle hub and may comprise at least one of: an extended flange which may be disposed between a pilot hole and the vehicle hub, a multiple piece cover portion which may fully cover the pilot hole, drain slots disposed on the vehicle wheel and wherein the drain slots may have a slope of at least five degrees, or an enhanced bushing which may create a non-flat profile between the vehicle wheel and a fixation device.

Variation 16 may include the isolation feature of Variation 15 wherein the vehicle wheel may be comprised of magnesium.

Variation 17 may include the isolation feature as set forth in any of Variations 15 or 16 wherein the vehicle hub may be comprised of steel.

Variation 18 may include the isolation feature as set forth in any of Variations 15-17 wherein the drain slots may have a slope of up to fifteen degrees.

Variation 19 may include the isolation feature as set forth in any of Variations 15-18 wherein the drain slots may have a width of up to 20 mm.

Variation 20 may include the isolation feature as set forth in any of Variations 15-19 wherein a width of a distal end of the drain slot may be smaller than a width of the proximal end of the drain slot.

The above description of select variations within the scope of the invention is merely illustrative in nature and, thus, variations or variants thereof are not to be regarded as a departure from the spirit and scope of the invention.

What is claimed is:

1. A vehicle comprising
a vehicle body;
a vehicle hub operably coupled to the vehicle body;
a vehicle wheel operably coupled to the vehicle hub, wherein the vehicle wheel is isolated from the vehicle hub by at least one isolation feature comprising:
an extended flange portion of the vehicle wheel disposed between a pilot hole and the vehicle hub;
a multiple piece cover portion fully covering the pilot hole;
drain slots disposed on the vehicle wheel, wherein the drain slots have slope of at least 5 degrees; or
an enhanced bushing creating a non-flat profile between the vehicle wheel and a fixation device.

2. The vehicle of claim 1, wherein the vehicle wheel comprises magnesium.

3. The vehicle of claim 1, wherein the vehicle hub is comprised of steel.

4. The vehicle of claim 1, wherein the fixation device comprises steel.

5. The vehicle of claim 1, wherein the drain slots have a slope of up to 15 degrees.

6. The vehicle of claim 1, wherein the drain slots have a width of up to 20 mm.

7. The vehicle of claim 1, wherein a width of a distal end of the drain slot is smaller than a width of the proximal end of the drain slot.

8. A vehicle comprising:
a vehicle wheel operably coupled to a vehicle hub, wherein the vehicle wheel is isolated from the vehicle hub by one or more of the following:
an extended flange portion of the vehicle wheel disposed between a pilot hole and the vehicle hub;
a multiple piece cover portion fully covering the pilot hole;
drain slots disposed on the vehicle wheel, wherein the drain slots have slope of at least 5 degrees; or
an enhanced bushing creating a non-flat profile between the vehicle wheel and a fixation device.

9. The vehicle of claim 8, wherein the vehicle wheel comprises magnesium.

10. The vehicle of claim 9, wherein the vehicle hub comprises steel.

11. The vehicle of claim 10, wherein the fixation device comprises steel.

12. The vehicle of claim 8, wherein the drain slots have a slope of up to 15 degrees.

13. The vehicle of claim 8, wherein the drain slots have a width of up to 20 mm.

14. The vehicle of claim 8, wherein a width of a distal end of the drain slot is smaller than a width of the proximal end of the drain slot.

15. An isolation feature constructed and arranged to isolate a vehicle wheel from a vehicle hub comprising at least one of:
an extended flange disposed between a pilot hole and the vehicle hub;
a multiple piece cover portion fully covering the pilot hole;
drain slots disposed on the vehicle wheel, wherein the drain slots have slope of at least 5 degrees; or
an enhanced bushing creating a non-flat profile between the vehicle wheel and a fixation device.

16. The isolation feature of claim 15, wherein the vehicle wheel comprises magnesium.

17. The isolation feature of claim 15, wherein the vehicle hub comprises steel.

18. The isolation feature of claim 15, wherein the drain slots have a slope of up to 15 degrees.

19. The isolation feature of claim 15, wherein the drain slots have a width of up to 20 mm.

20. The isolation feature of claim 15, wherein a width of a distal end of the drain slot is smaller than a width of the proximal end of the drain slot.
